(19) United States
(12) Patent Application Publication
(10) Pub. No.: US 2009/0131014 A1
(43) Pub. Date: May 21, 2009

(54) Method and system for dynamic spectrum allocation and management

(76) Inventors: Alex Mashinsky, Memphis, TN (US); Clifford Rosen, New York, NY (US)

Correspondence Address: COHEN, PONTANI, LIEBERMAN & PAVANE LLP, 551 FIFTH AVENUE, SUITE 1210, NEW YORK, NY, 10176, US

(21) Appl. No.: 12/313,458

(22) Filed: Nov. 20, 2008

Related U.S. Application Data
(62) Division of application No. 10/471,712, filed on Apr. 7, 2004.

(51) Int. Cl. H04M 11/00

(52) U.S. Cl. 455/405

(57) ABSTRACT

An arrangement for dynamic account allocation is achieved by pooling together spectrum and network availability, as well as congestion information, from different service providers in a central database and by the purchase of wholesale volume of network capacity or accounts with predetermined monthly usage. The purchased network capacity is dynamically allocated of devices of different origin and ownership. The central system operator administrates the rebilling and reconciliation of any fractional usage to each device. Unlike other proposed solutions that require the carriers to bet on proprietary technologies and involve changes to the network and high capital expenditures to build and operate the network, the present invention requires no changes to the carrier's network and no investment in a proprietary solution

### CROSS-REFERENCE TO RELATED APPLICATIONS

This application is a Divisional of U.S. patent application Ser. No. 10/471,712, filed Apr. 7, 2004, which claims priority from U.S. Provisional Application Ser. No. 60/275,818 filed Mar. 14, 2001, and U.S. Provisional Application Ser. No. 60/357,545 filed Feb. 15, 2002, the disclosure content of which are hereby incorporated by reference in their entirety.

### BACKGROUND OF THE INVENTION

1. Field of the Invention

The present invention relates generally to telecommunications, and relates more particularly to a method and system for dynamic spectrum allocation and management in a wireless telephone/data system.

2. Description of the Related Art

The current wireless telecommunications industry faces several challenges to growing and expanding the services that are offered. The first challenge is that spectrum availability for wireless communications is highly sought after but exceedingly scarce. The shear magnitude of the cost for spectrum licenses confirms this challenge. For example, $32 billion dollars were raised in spectrum auctions in the U.S. between 1994-1999. In the United Kingdom and Germany, $35 and $46 billion dollars were raised, respectively, for spectrum licenses.

The second challenge facing the wireless industry is that demand for wireless services is growing at a phenomenal rate, including demand for both voice and data transmission services. Some organizations predict that the number of wireless subscribers will exceed 1 billion by 2004 while other groups predict that wireless web surfers will grow from 6 million in January, 2000 to 484 million in 2005. Still others predict that global data revenues will grow from $7.3 to $65.2 billion and the wireless data market will exceed $82 billion by 2012.

Beyond these fundamental economic problems, there are key obstacles to overcome with the design and implementation of today's wireless networks to facilitate new growth. One of the biggest obstacles in the industry is the coupling between wireless devices and specific carrier networks. This coupling restricts which devices can talk to which network towers, which in turn greatly diminishes the efficiency of capacity distribution. The restrictions occur in two forms. The first form involves physical incompatibilities between the devices of one carrier, and the network towers of another carrier. These incompatibilities occur at the level of the “air interface.” There are approximately 5 voice interfaces (AMPS, CDMA, TDMA, GSM, iDEN) and 6 data interfaces (GPRS, CDMA 1x, Wi-Fi, CDPD, DataTAC, Mobitex) in broadscale use within the U.S. alone. The second form of access restriction involves carrier support for inter-carrier operation. Assuming a device from Carrier A is physically compatible with a network of Carrier B, the device can not access Carrier B's network unless the two carriers have expressly made arrangements for such “roaming” between carriers. In many cases, such inter-carrier access is not possible because the necessary agreements have not been obtained.

These restrictions have the overall effect of diminishing the efficiency of the network system. This effect, which may be called “unbalanced usage”, can be demonstrated with reference to three network entities: a tower from Carrier A, a wireless device subscribing to Carrier A and a tower from Carrier B. Suppose the device is within range of only these two towers. Suppose further that the tower from Carrier A is at capacity and cannot accommodate communication with the device while the tower from Carrier B is underutilized. It is beneficial for the device to access the tower from Carrier B because the device gets a communication channel and Carrier B gets to sell unused available capacity.

Since unbalanced usage is a common problem in the art, there are several existing systems that attempt to alleviate the problem. However, an overwhelming majority of the systems only reduce unbalanced usage within a single band, such as TDMA or CDMA. One such system dynamically controls a time slot in a TDMA system by constantly exchanging information regarding a data transfer between a central controller and a wireless device. In that manner, the time slot is dynamically allocated in response to constantly changing system requirements, and the overall capacity consumed for the transfer is minimized. In another system, the usage of a wireless network is monitored so that different channel allocations can be made to best suit the usage patterns of the wireless network. All of these systems operate exclusively within one mode, such as TDMA, and these systems cannot alleviate unbalanced usage between two or more modes, for example an overloaded CDMA network and an underutilized GSM network. While there are other unimplemented systems in the art designed to alleviate unbalanced usage between two or more modes, these systems require base stations that are each capable of processing several different modes, unlike the existing base stations, which can only operate in one mode. In addition, the system is incapable of dynamically changing modes during an existing session. These systems have the disadvantage of prohibitively high cost since all base stations in the network would have to be modified. Given the networks already exorbitant outlays of money for government licenses and base station development, networks are loath to reconfigure every base station in this manner.

A further obstacle in the industry is that carriers couple application services to their own proprietary network. This results in a limited selection of quality content and applications for wireless subscribers. Overcoming this problem would require that all wireless systems adopt an open transport system with a common addressing scheme, such as TCP/IP, and that devices are capable of freely downloading new client applications for network services that make use of this transport. Indeed, there seems to be a trend along these lines, but this trend will require technology solutions such as the present invention to facilitate multi-network access in order to gain broad adoption.

A further obstacle in the current wireless systems is the lack of support for administration of spectrum usage. For example, in times of crisis the need arises to enforce a priority access mechanism across all available networks. Current network technology does not provide for this.

Yet another obstacle in the current wireless systems is the lack of a system for the real time collection and analysis of operational data, such as usage, QOS, pricing, capacity, etc. Such capabilities are only just now being introduced on a per-network basis, and are only appearing in limited forms. Clearly, the need remains for a powerful, inter-network system that offers these capabilities in order to optimize the distribution and consumption of wireless capacity. Moreover, the availability of such a system would enable for the first time a real-time analysis that correlates spectrum supply with demand across parameters such as price, mode, capacity, geography, etc.

Referring to FIG. 1, there is shown a general overview of a prior art wireless network architecture. There are several proprietary networks 12 that each typically work on a single frequency (e.g., 700 MHz or 1900 MHz). The owners of the networks generally utilize a plurality of proprietary application servers 10 that provide service only to the network that they are attached to. In addition, they may utilize one or more third party applications servers 10a which are often shared over multiple carrier networks. A plurality of wireless telephones 16 are equipped to function on only the frequency/mode pair of one specified network 12. Additionally, the wireless networks may be used to support communication between two wireless devices, or between a wireless device and a wireline device other than a server, such as a landline phone. Currently, there are multi-mode devices that can operate on more than one frequency (e.g., 800 Mhz and 1900 Mhz) and more than one mode (i.e. AMPS and CDMA), but they cannot dynamically choose a mode. The plurality of wireless telephones 16 communicate with networks 12 through a plurality of base stations 14, often called Base Station Systems (BSSs) and Mobile Switching Centers (MSCs). The base stations 14 are typically outfitted with a particular network technology, and are not easily hardware upgradeable. While third party application servers 10a must work with the owners of the network 12 to provide services/content (e.g., stock quotes, weather, etc.), most providers of servers 10a have difficulty bringing new offerings to market because typically the networks 12 want to rely on their own application servers 10, which provide better profit margins.

A developing technology called Software Defined Radio (SDR) overcomes many of the limitations of the current systems and provides many benefits to users, operators, and manufacturers in the wireless industry. SDR is defined by the Federal Communications Commission (FCC) as a transceiver with operating parameters that can be altered via software. Some of the specific opportunities that SDR helps to enable include interoperability between different cellular telephone standards and easier deployment of new applications.

While SDR lowers the existing physical barriers to achieving a more efficient wireless system, SDR alone will merely exaggerate the remaining shortcomings of wireless systems. Accordingly, there remains a need for a method and system for dynamic spectrum allocation and management across multiple wireless networks that does not require substantial changes to the existing network architecture.

### SUMMARY OF THE INVENTION

It is therefore an aspect of the present invention to provide for the dynamic allocation of segments of spectrum which may be available from different providers in a manner best suited to realize the objectives of various network entities.

It is an additional aspect of the present invention to balance the use of network systems in times of a crisis and provide near exclusive use to emergency workers by artificially inflating the priority of certain calls.

It is a further aspect of the invention to allow a service provider to purchase a small number of accounts from each network targeted for roaming, and then loan those accounts on an as needed basis to devices based on where they are currently roaming.

It is still a further aspect of the present invention to dramatically increase the longevity of the battery used in such wireless devices by allowing devices to dynamically select a provider based on power needs in addition to other criteria such as price and throughput.

It is a further aspect of the invention to enable a common transport and addressing scheme across multiple networks operated by different carriers using different network technologies.

To achieve the above and other aspects of the present invention, there is provided a process and system that allows for any device compliant with one or many networks to “borrow” an account, authenticate in that specific network, use it for a period of time and then use some other network as necessary. The decision to select a different network may be initiated by various network entities, including wireless devices, carriers, spectrum owners and spectrum administrators, thereby decoupling wireless subscribers from specific carriers, and decoupling subscriber accounts from specific devices. The ability to borrow an account facilitates authentication and billing. The invention applies to any and all wireless devices, whether fixed or mobile, or used for voice, data or device to device (i.e. telemetry) applications.

This invention maximizes the allocations of a device within its own network, across multiple networks or as an unaffiliated user with an on demand access request. By using existing in-band control channels or out-of-band (not same providers) control channels, a multimode/SDR equipped wireless device according to the present invention can detect a signal sent by all providers in an area and store pertinent information for later use in an internal or external database (“DB”). This information is used to select which network to access for the service.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings, wherein similar reference characters denote similar elements throughout the several views:

FIG. 1 is a schematic diagram of a wireless network according to the prior art;

FIG. 2 is a schematic diagram of a first exemplary wireless network in accordance with the present invention;

FIG. 3 is a schematic diagram of a second exemplary wireless network in accordance with the present invention;

FIG. 4 is a block diagram of a wireless device for use with the present invention;

FIG. 5 is a schematic diagram illustrating an inter-network transport and addressing scheme according to the present invention;

FIG. 6 is a flowchart depicting a first operation of the wireless device in accordance with the present invention;

FIG. 7 is a flowchart depicting a continuation of the operation of the wireless device of FIG. 6;

FIG. 8 is a system which allows a wireless device to borrow and use a wireless account according to the present invention;

FIG. 9 is a schematic diagram of a database accessed by the wireless device of FIG. 4;

FIG. 10 is a flowchart depicting a method for requesting carrier reselection performed by the wireless device of FIG. 2;

FIG. 11 is a flowchart depicting a method performed by a spectrum management server in response to a request for carrier reselection according to FIG. 10;

FIG. 12 is a flowchart further depicting the step of switching as described in FIG. 10;

FIGS. 13A-C are schematic diagrams of a wireless network during the operation of carrier reselection using the proxy server in accordance with the present invention;

FIG. 14 is an interaction model depicting a system according to the present invention; and

FIG. 15 is an exemplary data model for use with the system according to FIG. 14.

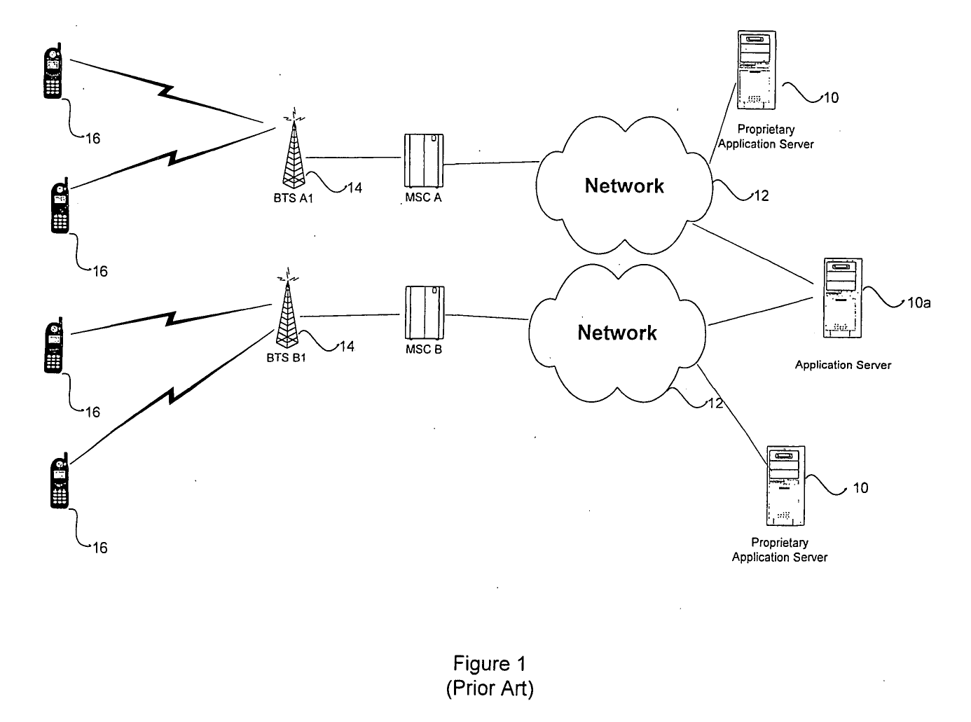

### DETAILED DESCRIPTION OF THE PREFERRED EMBODIMENTS

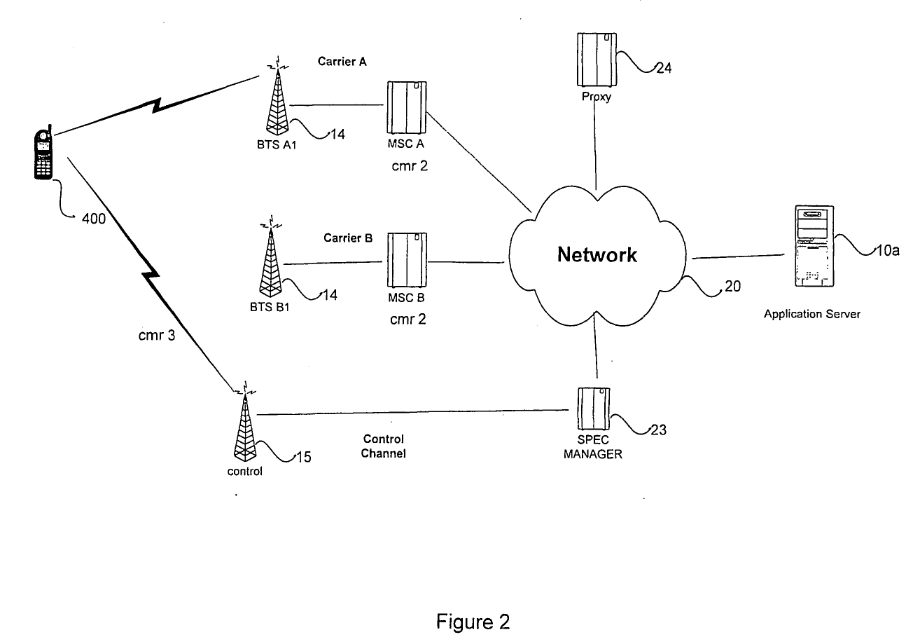

Referring now to FIG. 2, there is shown a schematic diagram of a wireless network 20 having an intelligent spectrum management server 23 in accordance with the present invention. In this embodiment, network 20 is comprised of separate networks from multiple network carriers, connected to at least one proxy server 24 and at least one spectrum management server 23. Spectrum management server 23 can efficiently manage the available spectrum as well as deploy and expand the application server 10, 10a offerings. The spectrum management is achieved primarily through receiving information about available capacity from the network carrier's MSCs, and making intelligent allocation decisions by combining intelligence in the spectrum management server 23 with intelligence in the wireless device 400. Communication between the spectrum management server 23 and the wireless device 400 is transmitted along a control channel maintained by a control base station 15. The control channel may be an in-band or out-of-band channel of carrier A or B, or an altogether different carrier. In the case where the control channel is in-band, base station 14 and control base station 15 would be one in the same. With current technology, the control channel may use a frequency of 220 MHz, existing packet data networks such as DataTAC, Mobitex, GPRS, CDMA 1x, CDPD, or many other bearer services in many other bands. In some cases, the control channel may even be the same as a data channel. A proxy server 24 is used to facilitate the spectrum allocation determined by the spectrum management server 23 and wireless device 400. In addition, the spectrum management server 23 may facilitate the deployment of new software to SDR capable base stations 14 and devices 400 to support additional radio protocols required for a new application.

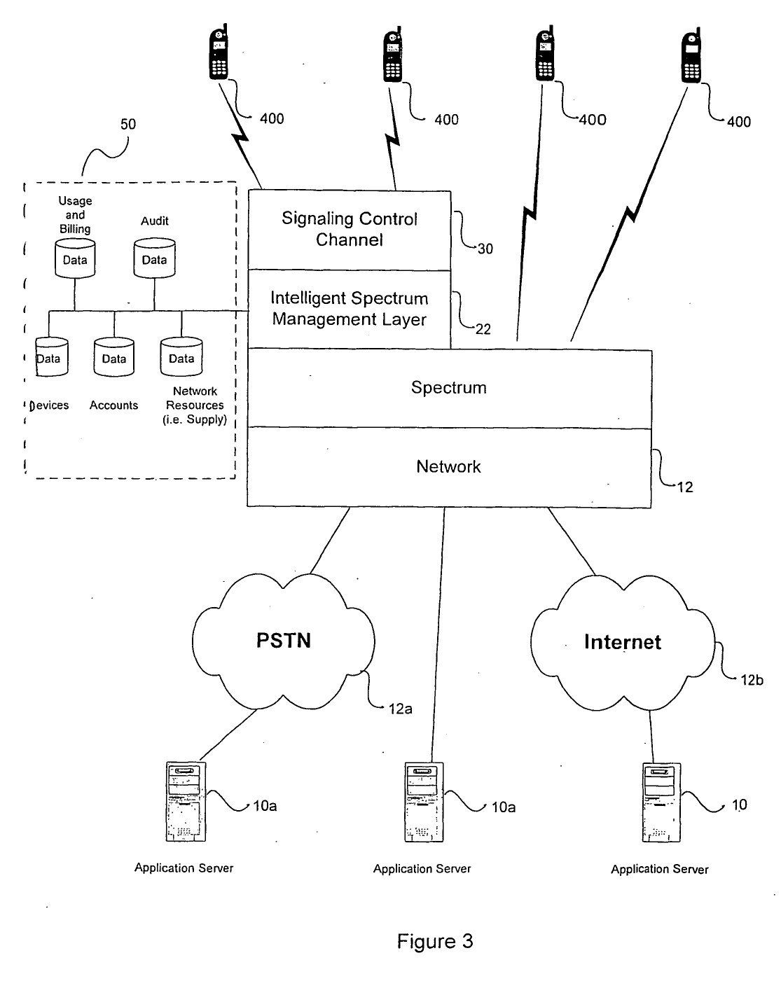

FIG. 3 is a schematic diagram of an embodiment of the present invention. In this embodiment the wireless device 400 communicates with the base stations 14 and 15 (not shown) and other networks 20 (e.g., a public-switched telephone network (PSTN) 12A, and the Internet 12B) to communicate with application servers 10, 10a. Additionally there is a spectrum management layer 22 that is responsible for determining available network channels for a given transmission and for allocating channels to wireless devices. Involved in this function is a signaling control channel 30 that handles signaling between the wireless devices 400 and spectrum management layer 22. The spectrum management layer 22 may also ensure that once a channel has been used, that is returned to “available” status after the transmission is complete.

The spectrum management layer 22 is a highly intelligent, flexible and dynamic component within the system. It handles the use of spectrum through intelligent allocation using requests from any one of a wireless device, a proxy device or the network itself carried over either in band and/or out of band control channels. Each request may have different characteristics associated with it, such as Quality of Service, price, location, mode, band, application type, urgency, customer priority, power requirements, security, etc. If the request to switch carriers is device initiated, it may contain a list of network towers 14 that have been detected by the device, along with an array of information concerning each tower, such as the signal power, channel frequency, etc. The requests are examined by the spectrum management server 23 against a database 50 containing among other items, network channel capacity data. This database 50 may also include information such as availability, QOS, mode, band, price, etc. Additionally, the spectrum management servers 23 can derive information about the request. For example, if the request came from wireless device 400, and the device did not forward its own location information (via GPS), the spectrum management servers 23 could use triangulation to get an estimate for this value. In addition to the request data and network availability data, the spectrum management server 23 factors in its own goals (specified by the spectrum management server administrators) in order to arrive at an allocation. The resulting allocation could be a single network channel, with a single carrier over a specific mode and band, or else it could be an array of many channels. All such queries and selection of available network carriers may be performed automatically and without the need of user intervention.

The ability to communicate over the best available network provider is an advantage in times of crisis. The prioritization of emergency communications is difficult in today's network architecture. By artificially inflating price or QoS standards, a network provider can clear communication channels for government business and disaster relief workers on a real time basis. The need for this feature was never more apparent than during the Sep. 11, 2001 disaster that occurred in New York City, Washington D.C. and in Pennsylvania. In NY city, the calls from emergency personnel could not get through because of the high call volume and the inability of the network to prioritize call traffic or allocate specific spectrum capacity to specific sets of devices or users. While certain less popular wireless providers were underutilized, the popular wireless systems were inundated with calls from both emergency workers and concerned families. The present invention balances the use of these systems and possibly provide near exclusive use to emergency workers by artificially inflating the priority of certain calls and maximizing the usage of all of the available spectrum.

One aspect of the channel allocation intelligence involves the use of SDR in wireless devices 400 and base stations 14. Specifically, the spectrum management server 23 has knowledge of the device and network capabilities in this regard, and is programmed to optimize device/base station parings so as to maximally exploit the air interface capabilities of both. The spectrum management layer 22 may also advise a device to use a specific mode and band from the available channels so as to accommodate other less capable devices which could not make use of such channels. The spectrum management layer 22 may even facilitate the download of a software upgrade to the device's SDR subsystem in order for it to use a particular available channel.

Additionally, by using SDR technologies in conjunction with the spectrum management layer 22, application servers 10, 10a could easily deploy new applications on the existing networks and the spectrum could be managed to work efficiently for the new applications. This invention allows for the rapid creation of applications and services and the rapid deployment of them over a multitude of networks since the control of the feature set and the functionality and compatibility of hand held devices is transferred from the network operators to the application developers.

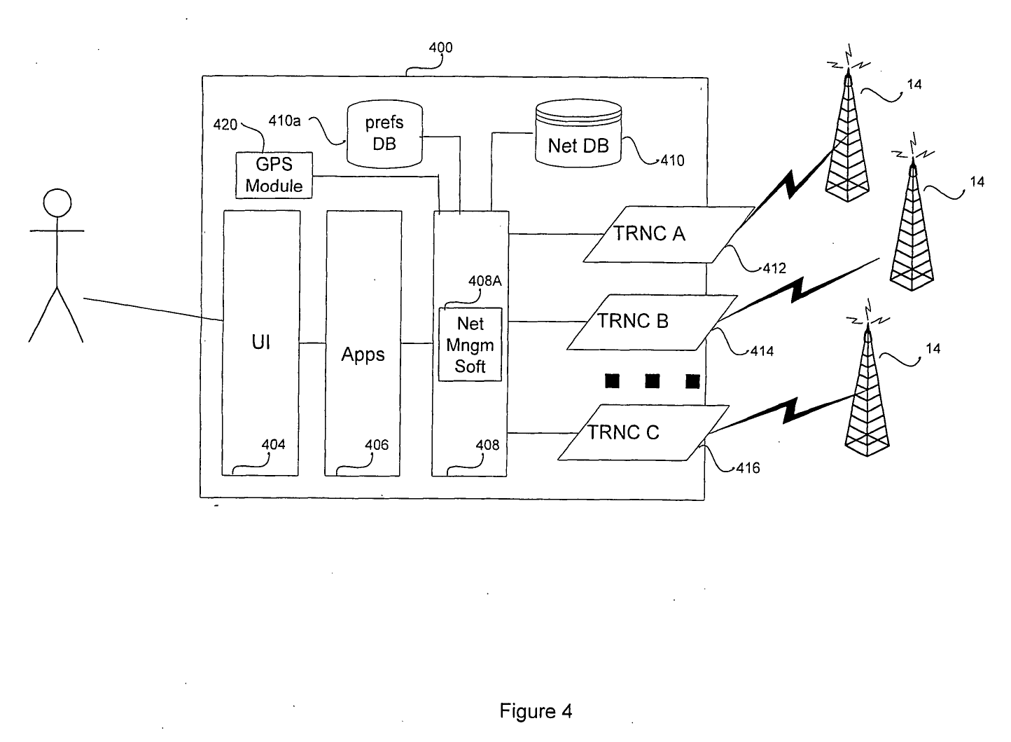

Referring to FIG. 4, there is shown a block diagram of a wireless device 400 for use with the present invention. A conventional wireless device 16 typically has one transceiver capable of communicating with other devices using a particular modulation mode over a particular band. In the present invention, however, the wireless device 400 has two or more, preferably three, transceivers. In FIG. 4, the wireless device 400 has a plurality of transceivers 412, 414, and 416. Each transceiver is capable of implementing any modulation mode over any frequency band. This may be accomplished using software such as software defined radio (SDR). The wireless device 400 of the present invention also has a network management controller 408 that runs network management programming 408a which enables device 400 to decide whether to switch from one modulation mode or band to another. Controller 408 interfaces with a device application 406, transceivers 412-416, an internal database 410, and an internal preferences database 410a. Preference database 410a permits a user to enter certain threshold values, which, when exceeded, can initiate a switch to another carrier. This information could be a quality rating on the various available modes and bands, available pricing information, signal strength, etc. Wireless device 400 also includes a Global Positioning Satellite (“GPS”) module 420, connected to controller 408, that obtains a precise geographical location of the wireless device. This GPS data may be sent to spectrum manage 23 for subsequent data processing or used to determine whether to switch carriers. The wireless device also has a number of components typically found in a conventional wireless device, such as a Liquid Crystal Display (LCD) for displaying incoming call numbers, a keypad for entering information, memory for temporarily storing information and an antenna for transmitting and receiving a signal which are not depicted in FIG. 4 for the sake of clarity.

Wireless device 400 may operate in the following manner. A wireless user manipulates a user interface 404 of wireless device 400 to start an application 406, say for example an FTP application. The network management controller 408 then launches network management software 408a and starts a session using transceiver A 412 over a particular mode or band. Note that the selection of the initial transceiver may include any idle transceiver, in addition, the particular mode or band chosen at startup may be the most efficient at the time of connection. All pertinent criteria corresponding to the first carrier is stored in database 410. As the session progresses, transceiver B 414 scans the airwaves over a variety of modes and bands at a predetermined interval and looks for a more efficient connection. All pertinent criteria collected by transceiver B 414 is then stored in the network database 410. This information may also be uploaded to external database 50 connected to network 20. The network management software 408a accesses the network database 410 according to a predetermined polling interval, and determines if there is another mode or band that is more efficient than the one currently in use. Efficiency in this case may mean a stronger carrier signal, or a better pricing plan, etc. The determination of efficiency may also make use of user preferences entered into and stored in database 410a. The network management software 408a then transmits a request to the spectrum management server 23 at the network end requesting to switch from one mode or band to another. This request may be made over an in-band carrier, or it may be made over an out-of-band carrier. This request may also be transmitted using transceiver B 414, as it is no longer scanning at this particular moment. After permission is granted and the necessary information for switch modes/carriers is obtained, a new connection using a new mode or band is established over transceiver C 416 the call proceeds seamlessly on transceiver C while the old connection over transceiver A 412 is dropped. Once the switching is done, transceiver B 414 may resume the scanning process. Note that the process may be completely performed using only two transceivers.

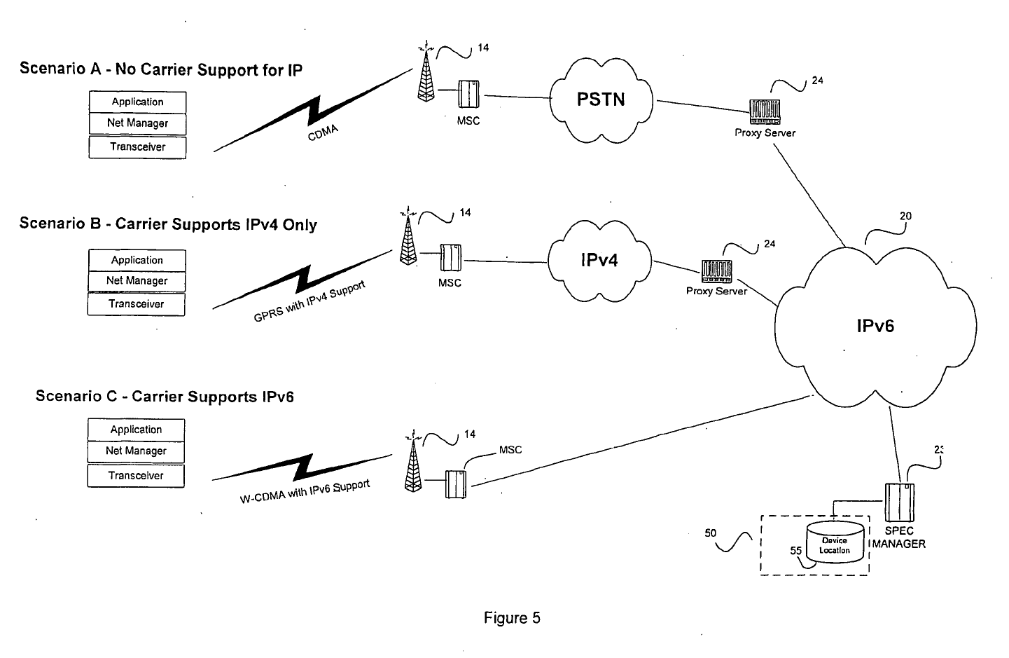

FIG. 5 demonstrates how network management software 408a within device 400 plays a role in providing an inter-network transport and addressing scheme. This scheme is achieved through the collaboration of three components: the network management software 408a within the device, the spectrum management servers 23 and the proxy servers 24.

The role of the spectrum management server 23 is to provide Ipv6 tunneling and direct communication to Proxy Server 24. The Proxy Server 24 provides the complimentary tunneling service to provide end to end communication.

As demonstrated in the figure, the inbound address management is enabled through a location database 55 which may be stored in database 50 and managed by the spectrum management servers 23.

In Scenario A, IPv6 is tunneled through a PSTN connection. From the carrier's perspective, it is merely completing a circuit switched call from the device to the Proxy Server. In Scenario B, IPv6 is tunneled through IPv4. The network management software encapsulated IPv6 within IPv4 until the packets reach the QW gateway. The Proxy Server extracts the IPV6 packets and then forwards as native IPv6. In Scenario C, end to end IPv6 is supported, so QW and the device are simply network elements in the IPv6 net.

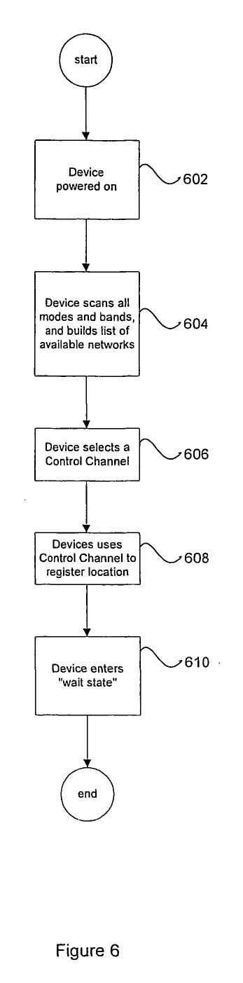

FIG. 6 is a flowchart depicting a first operation of the wireless device in accordance with the present invention. The device is first powered on by the user at step 602. Once the device is on, it scans at least one mode and/or band at step 604, and stores all pertinent criteria collected in network database 410 described in FIG. 4. The scanning may be done by any of the transceivers depicted in FIG. 4, as all of them are not in use at this time. A control channel is selected at step 606, which may be in-band or out-band. The device then registers its location to the spectrum management server 23 connected to the network and establishes a connection at step 608. The spectrum management server 23 processes the registration and stores it in a registration database which may be located in database 50. The registration database is similar in function to Home Location Registers (HLRs) commonly used in wireless systems. The wireless device 400 then enters a wait state at step 610 and waits for either an instruction to begin an operation from the user or instructions from the network to change carriers.

The registration is a vital aspect of the invention's ability to manage incoming communication. When a communication device wishes to initiate contact with a wireless device embodying this invention, that device uses a fixed address. This address actually belongs to a server that is part of the spectrum management system. The server discovers the devices true physical address by doing a lookup in the registration database. The server can then act as a gateway, or proxy, to provide a complete, end to end communication path.

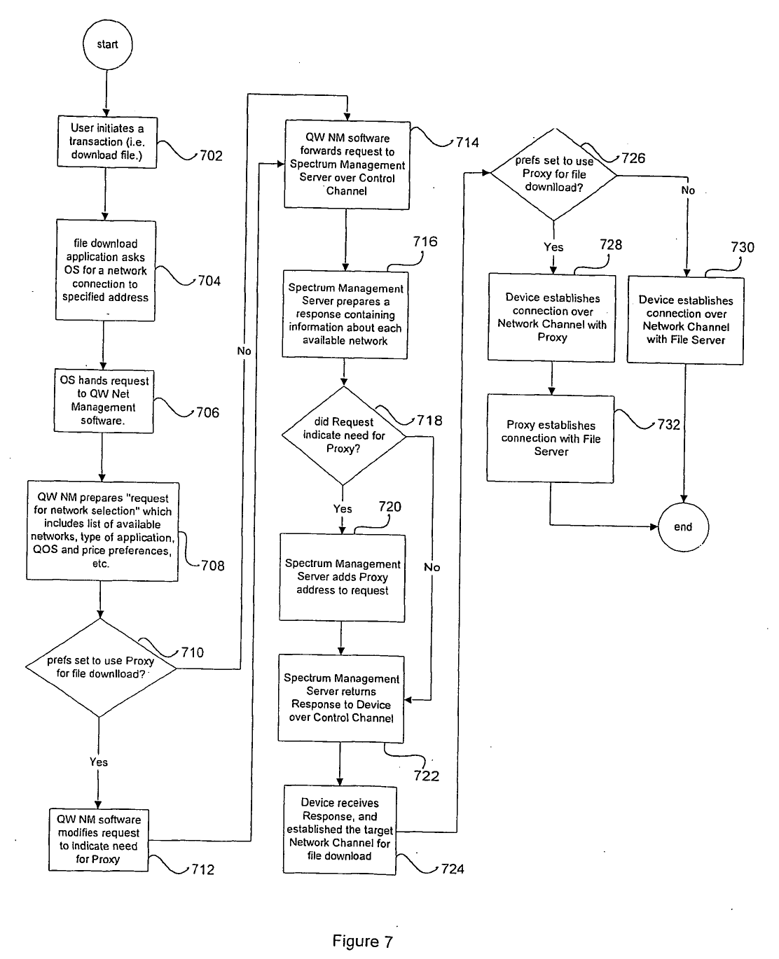

FIG. 6 depicts the operation of wireless device 400 booting up, while FIG. 7 is a flowchart depicting a continuation of the operation of the wireless device of FIG. 6. FIG. 7 depicts the operation of the wireless device 400 establishing a network session. The process depicted in FIG. 7 can only occur after the steps depicted in FIG. 6 have been completed. Wireless device 400 receives an instruction to begin an operation at step 702. The instruction may be by receiving an incoming phone call or user initiated, such as requesting to download a file. For the purposes of this application, the action of downloading a file is assumed. The download application 406 of the wireless device 400 asks the management controller 408 operating the wireless device for a network connection at step 704. The network management controller 408 processes the request and hands off the request to the network management software 408a at step 706. The network management software 408a reads the network database 410, which may already have information on a number of carriers from previous scans performed by the wireless device after booting up. Network management software 408a then prepares a request to communicate over a control channel with the spectrum management servers 23, listing one or more of the available carriers, at step 708. If the user has specified that a proxy server 24 should be used in the session, the network management software 408a checks user preferences in database 410a at step 710, and modifies the request to include a need for the proxy server at step 712. If the user does not wish to use proxy 24, then the network management software 408a sends the request without requesting for proxy server 24 to the spectrum management server 23 at the network side at step 714 over the control channel. The spectrum management server 23 processes the request at step 716 and formulates a response with the updated criteria regarding all of the requested carriers. The spectrum management server 23 also determines at step 718 whether the request contains a request for proxy server 24. If so, the spectrum management server 23 adds proxy server addresses associated the requested carriers to is response at step 720. The response is transmitted over the control channel to the wireless device 400 at step 722. The wireless device 400 receives the response at step 724, and determines from the updated criteria a more efficient carrier to use. If the proxy server 24 was requested, the wireless device 400 establishes a connection with the proxy server 24 specified by the spectrum management server 23 and begins communication at steps 728 and 732. If no proxy server is used, then the wireless device 400 establishes a network connection over a network channel at step 730. For the carrier reselection process mid-session described below, a proxy connection is assumed.

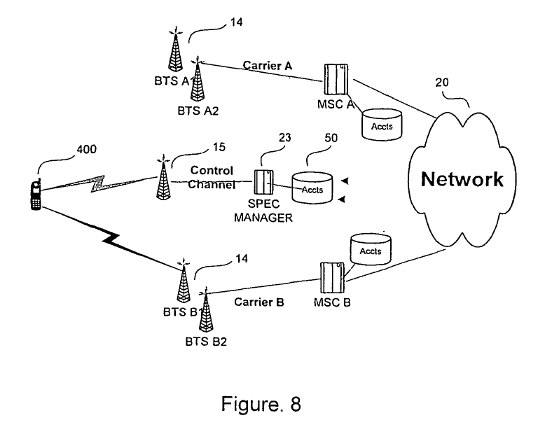

Thus far, the discussion of the invention has not directly addressed the functions of network authorization, accounting and billing. Referring to FIG. 8, the present invention describes a unique method of providing network authentication and accounting without requiring any hardware upgrade to existing network or roaming infrastructure on the part of the targeted carrier. This works by allowing a service provider to purchase a small number of accounts from each network targeted for roaming, and then loan those accounts on an as needed basis to devices based upon where they are currently roaming. The number of accounts to purchase would be roughly the max number of their subscribers likely to access that network concurrently.

All for-fee networks implement some form of an authentication and accounting system to ensure access is granted only to authorized users and at agreed upon rates. A device that subscribes to a given network is endowed with specific account information in support of this system. When the device wishes to access the network, it typically engages in a registration process, in which the device presents this information to the network, and the network verifies it against a valid subscriber database.

In the case of a roaming device, i.e. a wireless device not in a set home territory, there is an extra step in the registration process. After the device presents the account information to the network, the network examines this info and discovers that it belongs to another carrier. It must then transact with that other carrier to authenticate the user, and ensure the user has roaming privileges on the current network. Moreover, once the user is granted roaming access, all usage must be tracked in usage records, which must later be sent to a data clearing house to establish net charges. Finally, a financial settlement institution must provide the actual mechanism for the exchange of funds. Roaming systems are designed to handle this extra processing.

This entire process could be avoided, however, if a wireless device always used an account that was native to the network that it was accessing. One way to achieve this would be for an end user to procure accounts from multiple carriers, and program a custom device to use the right account at the right time. Clearly, such a solution would not be very convenient for the customer. Alternatively, a service provider (i.e. carrier or Mobile Virtual Network Providers (MVNO's)) could go through the trouble of procuring the necessary accounts and programming them into a custom phone. However, it would not prove cost effective for a service provider to setup the infrastructure to provide this functionality unless it was leveraged across a much greater customer base than its own subscribers. Additionally, having to procure one account from each carrier for each customer would not be very cost effective, since the provider would pay many times over for per-account administrative fees charged by the carriers.

Referring to FIG. 8, the present invention discloses a process and system which allows for any device compliant with one or many networks to “borrow” an account, authenticate in that specific network, use it for a period of time and then use some other network as necessary. This arrangement for dynamic account allocation is achieved by the purchase of wholesale volume of network capacity or accounts with predetermined monthly usage, and pooling of such accounts in a central database. The purchased network capacity is dynamically allocated to devices of different origin and ownership. The central system operator administrates the rebilling and reconciliation of any fractional usage to each device. Unlike other proposed solutions that require the carriers to bet on proprietary technologies and involve changes to the network and high capital expenditures to build and operate the network, the present invention requires no changes to the carrier's network and no investment in a proprietary solution.

The process for lending accounts through this architecture is initiated by a wireless device invoking a “request account” transaction over the control channel with the spectrum management server 23. The request includes the device ID, the carrier ID, and other information to ensure proper security. The spectrum management server 23 validates the request, returns the requested account data, and updates its account usage database to reflect the loan of the account to the specific device. At a later time, the account will be returned through a similar transaction over the control channel, and the database again updated to reflect that the device is through using the account. Thus, the account usage database contains sufficient information for the billing system to later map usage of that account to the proper device.

This system of account lending effectively decouples wireless devices from specific carrier networks. As such, for the first time, a company wishing to offer wireless service without owning and operating a network can do so without being at a disadvantage. These MVNO's can use this invention to gain cost effective network access across a multitude of carriers thereby providing their subscribers with the best possible coverage, QOS and price.

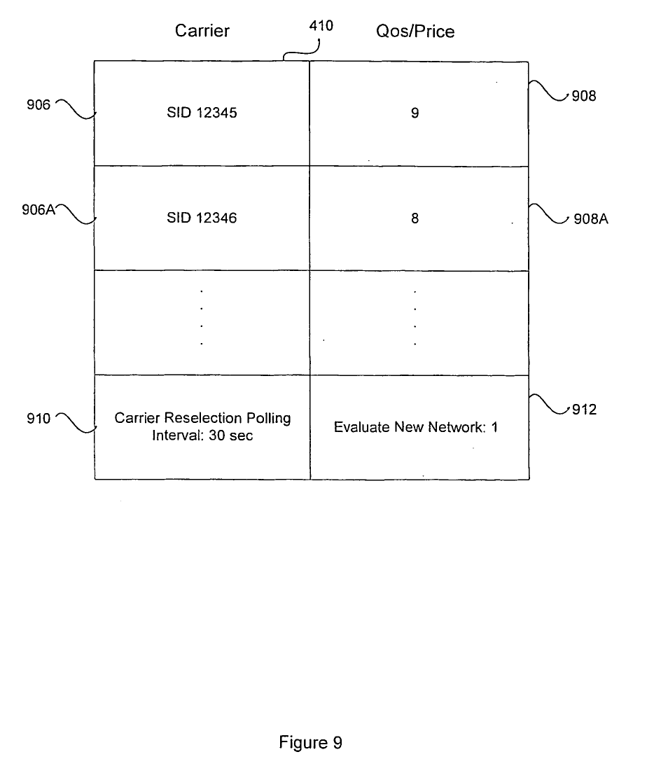

FIG. 9 is a schematic diagram of a database accessed by wireless device 400 in accordance with the present invention. More specifically, it is the network database 410 depicted in FIG. 4. The database is a table with at least two data fields, carrier data field 902, and QoS/Price data field 904. The carrier data field 902 contains the carrier ID of all the carriers scanned by the wireless device 400. One possible carrier ID is depicted as SID 12345, and is stored in memory location 906. The memory location 908 has the QoS/Price rating corresponding to the carrier identified by the carrier ID. The QoS/Price may be a scale from 1 to 10, with 1 signifying the best quality of service, while a 10 signifies the best pricing option. The QoS/Price rating is used by the network management software 408a of wireless device 400 to determine whether one carrier is more efficient than another.

The database also contains two other memory locations that are not part of the table. A memory location 910 contains the carrier reselection poll interval. As previously mentioned, the network management software 408a of the wireless device 400 reads the table of the network database 410 only at specific polling intervals. This polling interval is specified within memory location 910. In FIG. 9, an example of 30 seconds is used for the polling interval. The polling interval may, in system operation, be any length of time, wherein a zero would be that the network management software never reads the network database, and that a mode/band switch mid-session will never occur. Also, memory location 912 contains a Boolean value for evaluating new networks. In the current wireless system, certain wireless networks have a finite coverage area, and as a user roams from one point to another, he or she might come in and out of the coverage areas of several networks. A boolean value of 1 in memory location 912 would cause the wireless device of the present invention to scan the networks as the user enters their coverage areas, but a boolean value of 0 would prohibit the wireless device of the present invention from doing so.

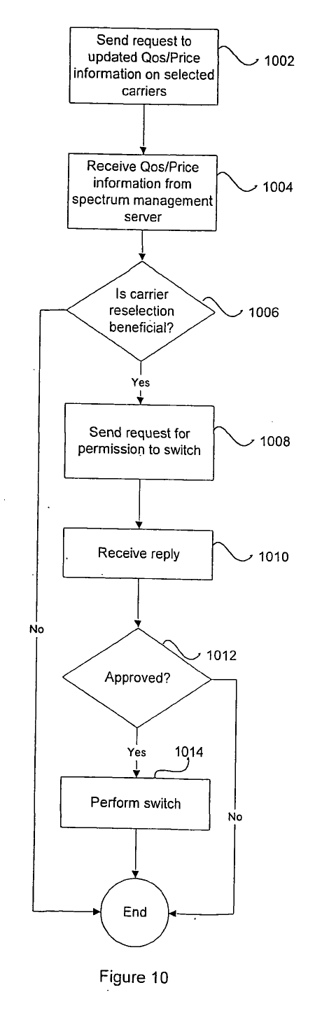

FIG. 10 is a flowchart depicting a method for requesting carrier reselection performed by the wireless device of FIG. 4. As discussed previously, the network management software 408a in FIG. 4 scans the network database 410 at a predetermined polling interval 910, and determines whether the wireless device 400 should switch to a more efficient carrier. FIG. 10 depicts the detailed operation of the wireless device 400 once the network management software 408a decides a switch should be made. The wireless device 400 first sends a request to the spectrum management server 23 on the network for updated QoS/Price information at step 1002. The request may only be for the current carrier in use, and the carrier that the wireless device wants to switch to. The reply from the spectrum management server 23, containing the QoS/Price information is received at step 1004. An examination on the new updated information is performed, and a new determination is made as to whether it is beneficial to switch to a new carrier, at step 1006. A switch is beneficial if the second carrier has a value that is better than a corresponding value of a first carrier. For example, if the price per minute of a first carrier is 6 cents and the price per minute of a second carrier is 4 cents, then it is beneficial to switch. Likewise, if the signal strength of a first carrier is stronger than that of a second carrier, it is not beneficial to switch. Numerous combinations are envisioned when determining what is beneficial. In times of an emergency, available spectrum with a higher QoS is beneficial even if it is at a higher price.

Switching based upon signal strength has an added benefit of dramatically increases the longevity of the battery used in such wireless devices by allowing devices to dynamically select a provider based on power needs in addition to other criteria such as price and throughput. The SDR/multimode wireless device according to the present invention can reconfigure itself to use a protocol which requires less power or compression or processing thereby extending the battery life.

Referring again to FIG. 10, if the updated information differs from information first examined and a switch is no longer beneficial, then the process ends, the wireless device resumes the scan of other carriers, and the network management software 408a in the wireless device 400 examines the network database 410 again after the polling interval 910 elapses. If, however, the examination of the updated information determines that a switch if still beneficial, then the wireless device 400 sends a request for switch to the proxy server 23 at step 1008. A reply is received at step 1010. If the reply indicates approval, then the wireless device proceeds to the switching process at step 1014. The switching process, in a preferred embodiment, is done with a proxy server 24 and will be discussed in detail in the following drawings.

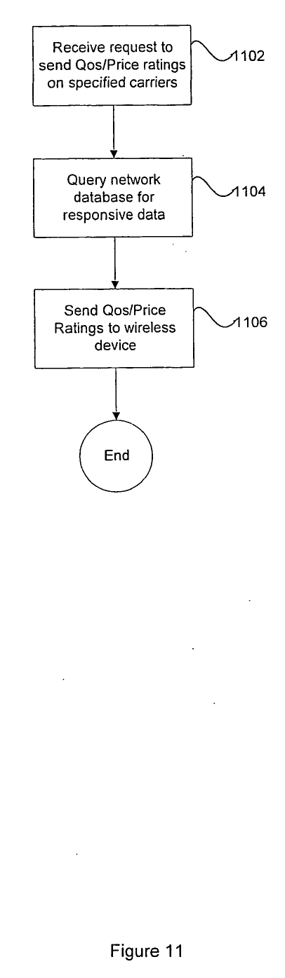

FIG. 11 is a flowchart depicting a method performed by a spectrum management server 23 in response to a request for carrier reselection according to FIG. 10. FIG. 11 depicts the operation of the spectrum management server 23 during the carrier reselection process described in FIG. 10. First the spectrum management server 23 receives a request from the wireless device 400 for updated QoS/Price ratings for specified carriers at step 1102. The number of specified carriers is most likely two, one being the carrier currently in use by the wireless device and the second being the carrier the wireless device would like to switch to. However, the number of specified carriers in the request can exceed two. After receiving the request, the spectrum management server 23 queries its own network channel database in step 1104 and transmits the updated QoS/Price information to the wireless device 400 at 1106. This concludes the spectrum management servers role in the transaction.

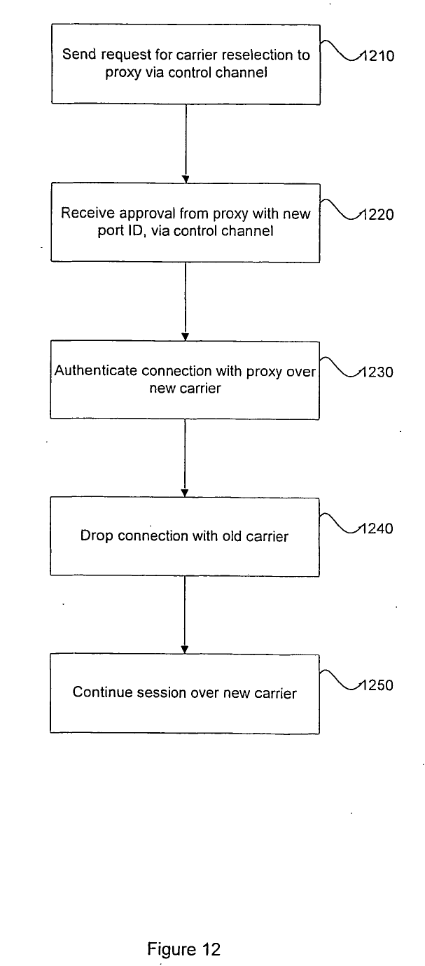

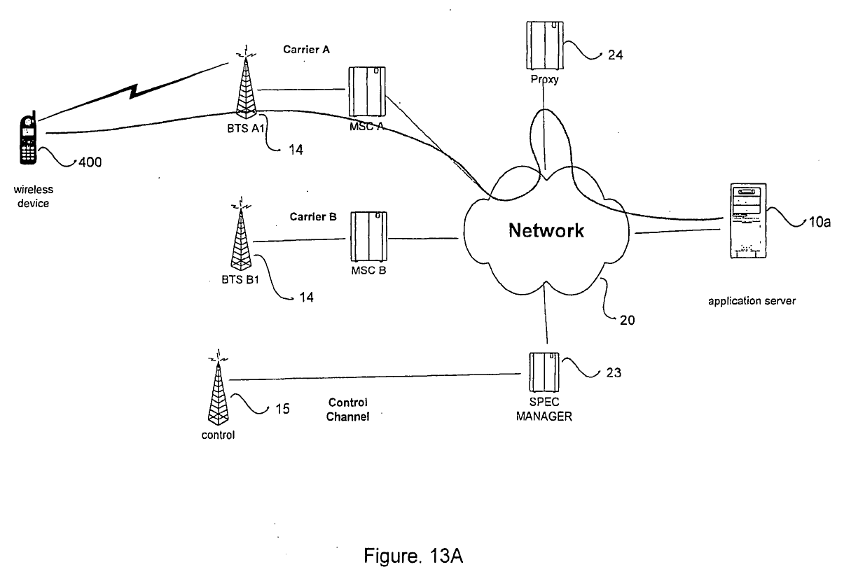

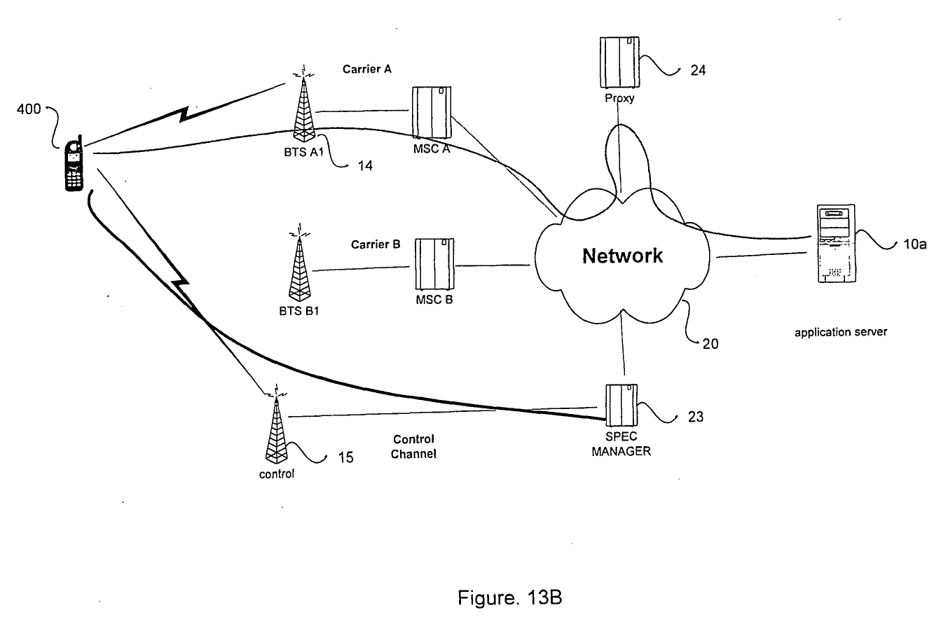

FIG. 12 is a flowchart further depicting the step of switching as described in FIG. 10 by discussing the process from the perspective of the Proxy Server 24. The wireless device 400, which is already engaged in communication with the proxy server 24 over the initial network channel, sends a request via the control channel to the proxy server 24 for carrier reselection at step 1210. The request contains the Session ID of the communication link over the initial channel, to identify the communication session which is the target of the request. An approval is received at step 1220, containing a port ID intended for the device to use when establishing a link over the new network channel. The approval is also received via the control channel. The wireless device then establishes a connection with the new port over the new carrier at step 1230. According to control communication over the control channel, the wireless device begins transmitting voice/data over the new carrier and drops connection with the old carrier at step 1240. The session continues uninterrupted over the new carrier at step 1250. The network device at the far side of the proxy server is unaware of the changeover.

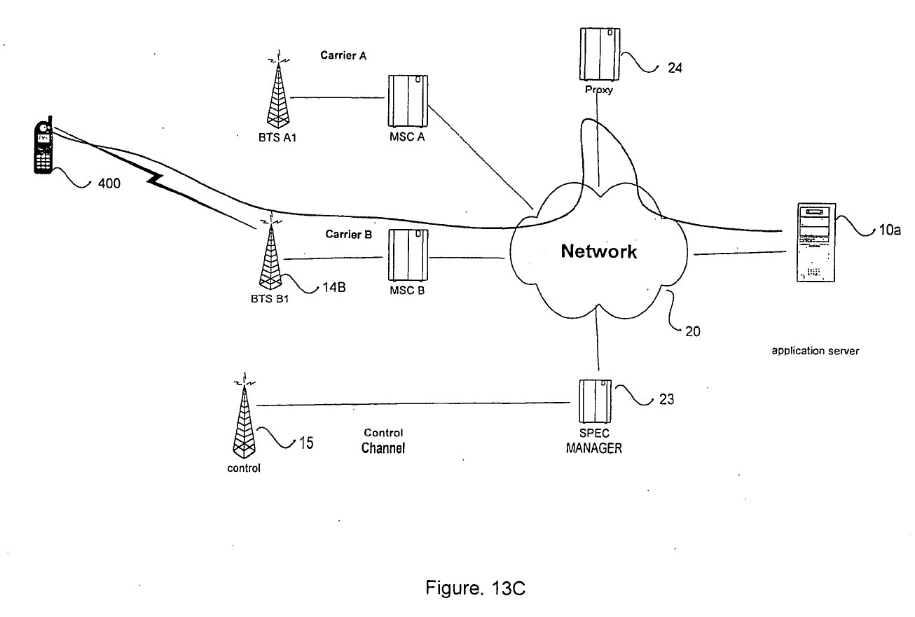

FIGS. 13A-C are schematic diagrams of a wireless network during the operation of carrier reselection using the proxy server 24 in accordance with the present invention. FIGS. 13A-C display the system architecture of the present invention. FIG. 13A shows the system architecture when the wireless device 400 is communicating over the currently used first carrier. The wireless device 400 has a connection with the base station 14, which in turn is connected to the application server 10, 10a on the network side through the proxy 24.

FIG. 13B shows the system architecture when the wireless device 400 requests information for carrier reselection from the spectrum management server 23. The communication is done over the control channel with control base station 15, so that communication over the first carrier through base station 14 is maintained. The result of this connection will be that the wireless device 400 will have enough information to make an intelligent decision about choosing a new network channel for communication with the proxy server 24.

FIG. 13C shows the system architecture after the wireless device has established a connection with the new second carrier over base station 14b. In the time between the moments represented by FIG. 12B and FIG. 12C, the wireless device 400 and the proxy server 24 performed the channel reselection transaction described in FIG. 12. A comparison of FIG. 13A and FIG. 13C shows that the carrier reselection process is transparent to the application server 10, 10a as its connection with the proxy server 24 is maintained throughout the reselection process. It is a goal in the present invention to use proxy server 24 so that the carrier reselection process is kept from being seen by the rest of the network.

In the embodiment described above, the mid-session carrier reselection process is triggered by the wireless device. It is also possible, in other embodiments, for the proxy server 24 or the spectrum management server 23 to trigger the carrier reselection. In the embodiment where the proxy server 24 triggers the carrier reselection, the network database, the scanning transceiver, and the portion of the network management software 408 that determines the most efficient carrier can be removed from the wireless device 400 and installed in the proxy server 24. The proxy server would then communicate with the spectrum management server over the control channel, obtain updated QoS/Price information from the spectrum management server, and establish a new connection over a new carrier with the wireless device 400 without interrupting the current session.

In the embodiment where spectrum management server 23 triggers the carrier reselection, the network database, the scanning transceiver, and the portion of the network management software that determines a more efficient carrier can be eliminated from the wireless device 400. The spectrum management server 23 would already have the necessary hardware and software to determine a more efficient carrier. Steps in the process of channel reselection described in other embodiments, such as sending a request to the spectrum management server for updated QoS/Price information, can be eliminated in this embodiment. The transaction would start with the spectrum management server 23 communicating with the device over the control channel, and requesting (or ordering) the device 400 to switch network channels. The device would then negotiate the remainder of the transaction, just as though it were device initiated.

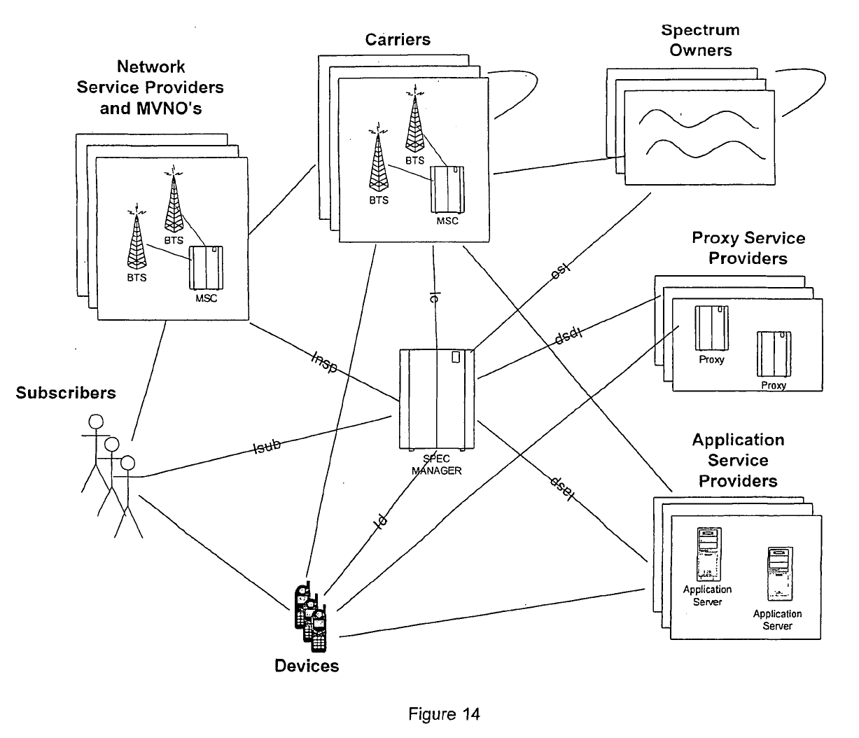

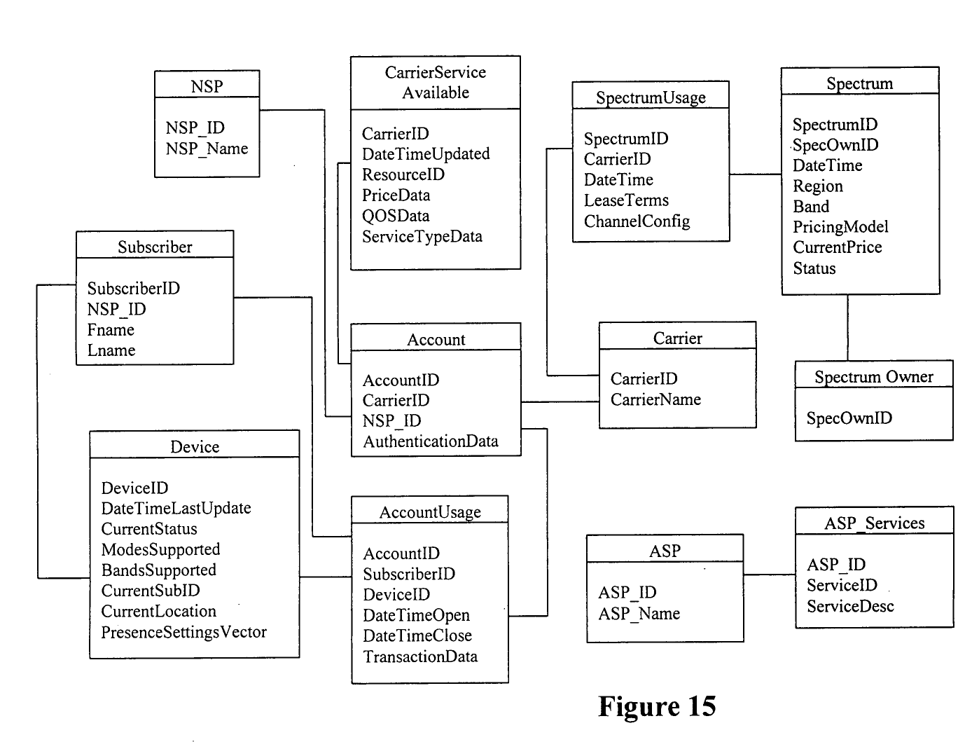

FIG. 14 along with FIG. 15 present the basis for a discussion of the invention's advanced features. This discussion is intended to demonstrate the method by which the following features are supported by the invention:

1. real-time network resource transaction environment (i.e. owner-to-carrier spectrum leasing, real-time carrier-to-carrier infrastructure trading, etc.)

2. enhanced operational analytic database

3. MVNO enablement, application service discovery

4. presence management.

This discussion will also present a more detailed look at the architecture of the Spectrum Management Server, which is a component of the invention.

To support this demonstration, a sample set of component interfaces and partial data model will be suggested, and used for examples. However, it is to be understood that these examples are not to be construed as a limitation on the invention as many changes and modifications may be made thereunto without departing from the spirit and scope of the present invention as defined in the appended claims.

FIG. 14 depicts an interaction model involving eight entities comprising the domain of the invention's system: users, devices, network service providers, carriers, spectrum owners, application service providers and proxy service providers. While most of these entities have been addressed in previous sections, the following text will further discuss each of these entities, along with their key interactions.

Spectrum Owner: a spectrum owner is an entity recognized as having air rights in a particular region for a particular band of spectrum, and possibly a particular application. Spectrum Owners monetize their spectrum either by leasing it to carriers, or else by becoming a carrier outright.

Carrier: a carrier is an entity that operates a wireless network. Carriers require spectrum. This requirement may be satisfied if the Carrier is also a Spectrum Owner, or if the Carrier leases spectrum from a Spectrum Owner.

Network Service Provider (NSP): an NSP is the entity that sells wireless capacity to subscribers. NSPs may also be Carriers. NSP's that are not carriers must purchase network capacity from existing carriers, and are often referred to as Mobile Virtual Network Operators (MVNO's.)

Subscriber: a subscriber, in this text, is defined as the person or entity that claims responsibility for the usage of the wireless device. In the case of a handheld computer, the subscriber is the person that logs on to use it (even if the “log on” is performed automatically by the device.) In the case of a wireless utility meter, the user is the department of the utility company that requested the network service provider to provision the wireless service. Subscribers may have many devices, and many network service providers. Subscribers purchase service from Network Service Providers. In this text, a subscriber may only purchase service from a Carrier if the Carrier is also an NSP. In other words, Carriers, per se, do not sell service directly to subscribers.

Device: a device is the physical mechanism which employs radio technology to gain access to a wireless network. A device may be operated by many different subscribers, where each subscriber has a different NSP, and each NSP has uses different mix of carriers.

Application Service Provider (ASP): devices typically communicate with other peer devices or with an application server. An application service provider is any entity which operates such an application server. ASP's may also be Carriers and/or NSP's, but they need not be either.

Proxy Service Provider: in certain instances, a device might need to communicate with an intended target node through an intermediary node. This is typically necessary to achieve some form of transparency in the communication. A proxy service provider is an entity which advertises and implements such nodes.

Spectrum Management Server: this is a centrally operated and readily accessible system that facilitates transactions between all of the above entities towards the end of enabling and optimizing functionality that serves the goals of each, as well as the spectrum management server's administration. Devices interact with the spectrum management server over a wireless control channel. All other components use conventional landline infrastructure, such as TCP/IP.

The capabilities of the spectrum management server can be understood by examining: 1) the interfaces defined between it and the other components, 2) the interface provided to its own administrators, and the underlying data model that supports the interfaces' transactions.

The following table conveys the general purpose of the interfaces by suggesting a possible set of transaction categories for each:

| | Transaction | |
|---|---|---|
| Interface | Categories | Transaction Requirements |
| Isub | Preference | Get and set subscriber preferences, such as how to prioritize |
| | Management | price vs. QOS. |
| Insp | Account Management | NSP's need to purchase accounts from various carriers, |
| | Subscriber | associate subscribers with their service, etc.. |
| | Management | |
| Ic | Spectrum | Carriers need to lease spectrum from spectrum owners, |
| | Management | publish pricing for available capacity, update QOS levels, |
| | Channel Management | register tower changes and adds, etc. |
| | Tower Management | |
| | Account Management | |
| Is | Spectrum | Spectrum Owners need to register spectrum they have for |
| | Management | sale/lease, publish and update pricing, etc. |
| Id | Registration | Devices keep spectrum management server updated on |
| | Channel Allocation | current location, contact server for channel allocation, etc. |
| | Session Management | |
| Ipsp | Service Registration | PSP's need to let spectrum management servers know what |
| | Service Management | services they are providing, update info on availability and pricing, |
| | | etc. |
| Iasp | Service Registration | ASP's need to let spectrum management servers know what |
| | Service Management | services they are providing, update info on availability and pricing, |
| | SDR Management | etc. They also need the services of the spectrum management |
| | | servers to target devices and other network nodes for software |
| | | updates to SDR sub-systems. |

FIG. 15 represents a portion of the data model, which supports and is manipulated by these interfaces. The following table provides examples of how the lo data instance within the model may be updated as a result of various transactions. This exercise is performed solely to illustrate the mechanism and concepts of the invention, and it is to be understood that a wide number of variations can be implemented without changing its scope and intent:

| Transaction | Data Recorded |
|---|---|
| Device registers with spectrum | Device UPDATE: date and time, current subscriber ID, current |
| management server | location, current status |
| Device opens a network | Device UPDATE: date and time, current status |
| channel | AccountUsage ADD: datetime open, accountID, subscriberID, |
| | deviceID, transaction data {mode, band, price, QOS . . .} |
| Device closes a network | Device UPDATE: date and time, current status |
| channel | AccountUsage UPDATE: date and time, datetime close |
| Carrier updates price in given | CarrierServiceAvailable UPDATE: date and time, price data, |
| network area | qos data, service data {mode, band, . . .} |
| | CarrierServiceAvailable ADD: CarrierID, datetime updated, |
| | resourceID, price data, qos data, service type data |
| Carrier adds new tower | CarrierServiceAvailable ADD: CarrierID, datetime updated, |
| | resourceID, price data, qos data, service type data |
| Carrier leases new spectrum | Spectrum Usage ADD: SpectrumID, CarrierID, DateTime |
| channel from spectrum owner | LeaseTerms, ChannelConflg |
| Carrier leases new spectrum | Spectrum ADD: SpectrumID, SpecOwnID, DateTime, Region, |
| channel from spectrum owner | Band PricingModel, CurrentPrice, Status |
| Carrier A loans spectrum to | SpectrumUsage UPDATE: CarrierID |
| Carrier B | CarrierServiceAvailable UPDATE Carrier A record |
| | CarrierServiceAvailable UPDATE Carrier B record |
| Carrier A loans network channel | CarrierServiceAvailable UPDATE Carrier A record |
| capacity to Carrier B | CarrierServiceAvailable UPDATE Carrier B record |

It is intended that the above text, tables and referenced diagrams should have duly demonstrated a system, process and methods for implementing a real-time network marketplace for network resources, as well as a mechanism for developing and maintaining a unique database of network entity activity and network resource availability. This database contains sufficient information to establish precise links between spectrum demand and spectrum supply through the entire supply chain (i.e. from spectrum owner, to network carrier to device consumer), where such information consists of data including pricing, location, mode, band, QOS, etc.

It is intended by the inventors that such database can be used for the planning and development of wireless network deployments, where planners can know for the first time the precise location, mode, band, capacity and QOS that is under supplied.

It is understood that the benefits of the present invention are not limited to voice communications since this invention also allows for the transmission of data segments or portions of communications over several sets of frequencies in one uninterrupted session utilizing one or more control channels. Such implementation will dramatically increase the security and throughput of any single device. In this scenario, the hand held or server breaks up a file or data stream into multiple segments or packets and transmits them over different carriers as described above. A second device or server collects the information from the multiple sessions and reassembles the individual packets into the original data stream or file. For example, if a multimode/SDR equipped wireless device is using a particular network and roams to a network covered with a 2.4 GHz free spectrum (“Wi Fi”) signal, the device may detect the higher capacity signal via the central database and request access. The device then reestablishes the connectivity with the server or device it was communicating with to continue the transaction at a higher bit rate. Such transaction may be initiated by the device or by the server or even by the network to free capacity for other high priority or higher price applications.

Thus, while there have been shown, described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for managing available spectrum in a wireless network having at least two available network carriers, comprising:
receiving a request at a management server for account data from a wireless device, the request containing at least a device ID identifying the wireless device and a current carrier ID identifying a carrier currently accessible by the wireless device;
validating the request at the management server;
returning, using the management server, the requested account data from a borrowed account to the wireless device requesting the account data based on the device ID and the current carrier ID; and
updating, using the management server, an account usage database to reflect the account usage of the wireless device based on the device ID and the current carrier ID.

2. The method according to claim 1, further comprising transmitting data from the wireless device to the management server indicating that the account is no longer required.

3. The method according to claim 2, further comprising updating the account usage database to reflect that the account is available.

4. The method according to claim 3, further comprising generating an invoice for the amount of account usage based on the device ID and the current carrier ID of the wireless device and storing the invoice in a billing database.

5. The method according to claim 1, wherein the step of validating the request further comprises:
comparing the device ID with a plurality of authorized device IDs stored in an authorized user database; and
authorizing the release of account data if the device ID matches one of the authorized device IDs.

6. The method according to claim 1, wherein the step of returning account data further comprises:
accessing a network resources database containing at least a list of available wireless carriers in a given geographic region; and
determining a suitable account for use by the wireless device using at least one predetermined selection criteria.

7. The method according to claim 6, wherein the at least one predetermined selection criteria is selected from the group consisting of Quality of Service (QoS), price per minute, available unused spectrum and signal strength.

8. The method according to claim 1, wherein the request is communicated over an in-band control channel.

9. The method according to claim 1, wherein the request is communicated over an out-of-band control channel.
